(19) United States
(12) Patent Application Publication
(10) Pub. No.: US 2008/0183559 A1
(43) Pub. Date: Jul. 31, 2008

(54) System and method for metadata use in advertising

(76) Inventors: Milton Massey Frazier, San Marcos, CA (US); Tim Smith, Carlsbad, CA (US)

Correspondence Address: ROGITZ & ASSOCIATES, 750 B STREET, SUITE 3120, SAN DIEGO, CA, 92101, US

(21) Appl. No.: 11/809,141

(22) Filed: May 30, 2007

Related U.S. Application Data
(60) Provisional application No. 60/897,715, filed on Jan. 25, 2007.
(60) Provisional application No. 60/897,687, filed on Jan. 26, 2007.

(51) Int. Cl. G06Q 30/00

(52) U.S. Cl. 705/10; 705/14

(57) ABSTRACT

Information is elicited from a consumer electronics device purchaser at the point of sale and used to provide targeted advertising to the purchaser and/or to facilitate service provision to the purchaser related to the CE device by a third party service provider and/or to provide the information to an entity for a fee such that the entity can provide targeted advertising to the purchaser to provide improved correlation of the purchaser with needed products or services.

This application claims priority from U.S. provisional application Ser. Nos. 60/897,715, filed Jan. 25, 2007 and 60/897,687, filed Jan. 26, 2007.

### FIELD OF THE INVENTION

The present invention relates generally to systems and methods for using metadata in advertising, product registration, website registration, and service registration.

### BACKGROUND OF THE INVENTION

Computers have fostered an explosion in the accessibility and availability of information that can be usefully mined for a variety of purposes. As recognized herein, a great deal of market information can be gleaned in retail outlets, and while much of the information currently is indeed used in one way or another, the present invention recognizes that far more information can be extracted for useful purposes at points of sales in, e.g., retail outlets and online. Indeed, the present invention recognizes that entirely new business can be afforded by such information in terms of sales of customer data, licensing, and the sale of advertising which can effectively exploit what might be thought of as “adsense”, an early warning image-based system fusing targeted, community-based advertising.

### SUMMARY OF THE INVENTION

A method is disclosed for using customer information including non-personally identifiable customer data collected at point of sale based on preferably customer opt-in for later advertising. Consumer information related to a consumer such as an individual person or a business concern is gathered from a merchant regarding a product to affect service registration and/or product registration and/or warranty registration. The method also includes gathering metadata from the consumer information from the point of sale to determine potential use of the product. Using the consumer information and/or the metadata from the consumer information, goods and/or services are marketed to the consumer.

The marketing of the goods and/or services may include direct marketing, advertising servicing and/or placement, rendering to the consumer product updates and/or services, and the correlation of other existing and/or future consumer information.

In another aspect, a method for detecting potential demand for second goods and/or services by a purchaser of first goods and/or services includes gathering consumer information related to a consumer from a merchant regarding a product at time of purchase to affect service registration and/or product registration and/or warranty registration. The registrations can occur immediately or hours, days, or months in the future. The method further includes gathering metadata from the consumer information from the point of sale to determine potential use of the product, and then providing the consumer information and/or the metadata from the consumer information to a third party service provider of goods and/or services. The provider thus is other than the merchant.

For instance, the third party service provider can be a retailer, a manufacturer, an owner of a website. The information and/or metadata may be used as marketing information to improve products and product mix. As an example, if the information and/or metadata indicates that consumers are buying many camera-enabled wireless phones with short-range radiofrequency communication capability, and secondary service information reveals problems transferring images from cell phones to TVs for display of the images, a TV manufacturer is given early warning of a consumer demand for TVs enabled with short-range radiofrequency communication capability.

In other non-limiting implementations the information and/or metadata is used to indicate updated consumer contact information. For example, the updated consumer contact information may be used to provide written or electronic advertising materials to the consumer either directly or through a third party aggregator by correlating data from the consumer, the purchased product, and a source at which the product was purchased, at that moment or later.

If the third party service provider is an owner of a website, the consumer can be offered a registration related to the website and to the product. In this example, the consumer provides additional information as part of the transaction, with the provider remitting consideration to a source at which the product was purchased based on the registration. Additionally, if desired the consumer may be offered the service associated with the website as a first option and if the user selects the first option and executes registration, the consumer is paid consideration by the provider. Still further, if desired the provider can display on the website advertisements for a manufacturer of the purchased product if the consumer executes registration selecting the first option.

In other non-limiting implementations the third party service provider is an entity desiring information or updates to information including contact information related to the consumer, and information is provided for a fee to the entity. The entity can then provide targeted advertising to the consumer to provide improved correlation of the consumer with needed products or services.

In yet another aspect, first consumer data is gathered at a point of sale of a consumer electronics (CE) device. The first consumer data is automatically gathered from a consumer-provided payment instrument such as a credit card and from a product identification. A consumer is incentivized to provide second data related to the consumer at the point of sale. The second data can then be used for a variety of reasons, including marketing additional products to the consumer, facilitating service provision to the consumer related to the CE device by a third party service provider, warranty registration, or providing the second data to an entity for a fee such that the entity can provide targeted advertising to the consumer to provide improved correlation of the consumer with needed products or services.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with present principles;

FIG. 2 is a flow chart illustrating non-limiting data gathering steps in accordance with the present invention to support the various use cases described herein; and

FIG. 3 is a block diagram of another non-limiting system in accordance with present principles.

### DETAILED DESCRIPTION OF THE PREFERRED EMBODIMENT

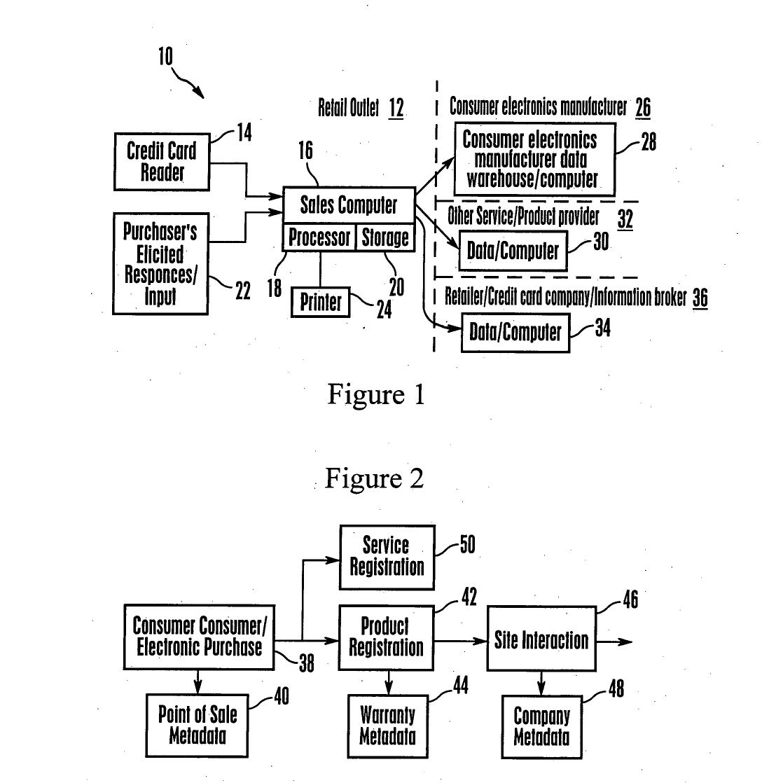

Referring initially to FIG. 1, a system is shown, generally designated 10, which includes one or more sources such as online or brick and mortar retail outlets 12 (only one shown for clarity) that sell products, and in particular consumer electronics (CE). Accordingly, within each retail outlet 12 are plural credit readers 14 or other consumer input devices (only one shown) for reading credit card information from credit cards that are swiped through the readers 14 (or placed close enough to exchange data using near field communications) and for sending the credit card information to one or more sales computers 16, each of which typically includes a processor 18 and local or remote disk-based and/or solid state data storage 20 for holding data and logic. Along with the credit card information, product information including product type, possibly product serial number, and so on is also entered into the sales computer 16 and correlated to a sales date when a store clerk enters this information, typically by scanning a bar code or other unique identification of the CE product.

In accordance with principles set forth further below, in addition to the above information the sales computer 16 can also receive information from the elicited responses 22 of a purchaser that may be input by any appropriate means, including scanning, keyboard entry, etc. As discussed below, this additional information is optional, i.e., it typically may be within the consumer's discretion to provide it or not. Sales receipts, warranty information, and various additional information in accordance with disclosure below may be printed out on a printer 24 or otherwise provided to the purchaser.

In accordance with the various use cases discussed below, the system 10 may also include a CE manufacturer site 26 with CE manufacturer computer system 28 and associated data warehouse that receives information from the retail outlet 12. In some implementations the retail outlet 12 may have a contractual relationship with the CE manufacturer 26 and/or be a “branded partner” of the CE manufacturer 26.

Also receiving information from the retail outlet 12 may be a service provider computer 30 at a service/product provider site 32, it being understood that the service/product provider is not the same as the CE manufacturer. The retail outlet 12 may further send information to a computer system 34 of another retailer or credit card company or information broker 36.

FIG. 2 illustrates how consumer data may be collected and used in various exemplary non-limiting use cases. At block 38 a consumer makes a CE purchase at the retail outlet 12 using, e.g., the consumer's credit card. The CE may be, without limitation, a digital camera, wireless phone, TV, computer, etc. In any case, at block 40 certain point of sale (POS) metadata is collected by the sales computer 16 including the consumer's credit card number, the type and number of CE purchased, the date of purchase, etc. The database may be internal to the POS, external to the POS, and owned by any of the entities described herein.

At the time of sale, the consumer advantageously may be offered, orally or in writing on, e.g., a monitor, to register the CE just purchased, and the consumer may elect to do so at block 42, generating what might be termed “warranty metadata”. As part of the process, the consumer is asked for the additional warranty metadata, which can include a current home address, a mailing address if different than the home address, a zip code, a telephone number, an email address, etc. As an incentive to provide the additional information, the CE manufacturer may offer, through the retail outlet 12, product discount coupons to the consumer, or service offers, or a discount on the current sale, or simplified cross-registration, etc.

Accordingly, with the above-discussed information a CE manufacturer use case can now be explicated. The information above is provided to the CE manufacturer 26 (by, e.g., sending the information over the Internet from the sales computer 16 to the CE computer system 28. The information is used as marketing information to improve products and product mix. As an example, if the information indicates that consumers are buying many camera-enabled wireless phones with short-range radiofrequency communication capability (e.g., so-called “Bluetooth” capability), and secondary service information gathered by the CE manufacturer reveals problems transferring images from cell phones to TVs for display of the images, the CE manufacturer is given early warning of a consumer demand for Bluetooth-enabled TVs.

In addition, because the warranty information at block. 44 can indicate consumer contact information that may represent updated information from that which may have been earlier gathered by the CE manufacturer, the manufacturer realizes increased marketing savings and sales. This can be manifested when, for instance, the CE manufacturer uses the updated contact information to provide written or electronic advertising materials to the consumer either directly or through a third party aggregator, made possible by the correlation of data from the consumer, the purchased CE, and the retail outlet 12 at which the CE was purchased. For example, by correlating the consumer contact information with the knowledge of where and what CE the consumer bought, the CE manufacturer can send to the consumer coupons or other promotional material that might offer discounts or other purchasing incentive for CEs that can be bought in the future at the retail outlet 12 specifically.

In addition to the above information that maybe gathered at the retail outlet 12 at the time of sale, at block 46 the consumer may be offered website registrations related to the purchased CE for various service providers having Internet-related businesses and services. As but one example, the purchaser of a digital camera might be offered registration on the website of a community photograph-sharing site such as “YouTube”. Or, the offered website registration may be for a photograph printing website. In the case of a purchased wireless device, the website registration offering may be for a telephony carrier. If the consumer agrees to such registration, the consumer provides additional information at block 48 that might be thought of as “company metadata” since it includes registration information of the consumer as it relates to the selected registration service provider 32. The information at block 48 can include preferences for other services/products, additional consumer demographic data, etc.

With this above explanation in mind, a service/product provider 32 use case may now be better understood. Assume for illustration that a website owner who desires relevant customers enters a contractual agreement with the retail outlet 12 to offer the above-described website registration at block 46 for relevant device(s) a consumer purchases. In exchange, the website owner pays to the retail outlet 12 a certain dollar value or reclamation for every “N” of consumers who register for the website at block 46. For the consumer's part, the consumer can be offered the contracting website or service as a first option but may opt for a secondary provider. To incentivize the consumer to select the first option, the consumer may be offered, at the point of sale, a discount on the purchased item and/or on the first option service if the consumer selects the first option.

Additionally or alternatively to the above, the website owner might agree to advertise the CE on its website. An advertisement may be presented for every new site registrant for a particular CE device. Still further, the website owner, or retail outlet, may also give information back to the CE manufacturer if the website gathers information indicating a change of the registrant's name or email address or physical (billing) address, etc., recognizing that the CE purchased at block 3 8 may have been purchased as a gift and thus facilitating increased metadata relating the purchased CE device.

Still further, the website owner may also insert advertisements from the CE manufacturer for every consumer that bought the CE device, assuming the device was registered with the website at block 46, charging the CE manufacturer 26 for the insertion. In some implementations the website owner may also provide information back to the CE manufacturer related to updated consumer information such as click through on advertisement, and other related data (behavioral metadata, analytical metadata, contextual metadata, and demographic metadata). Related third party information, such as advertisements relating to new discounted credit cards, changes in consumer information, etc., may also be provided to the consumer and to a related third party (e.g., to a credit card company) based on metadata from the website (e.g.,. click throughs by the same consumer on related or unrelated advertisements, etc.) Concluding the description of FIG. 2, block 50 indicates that as part of the point of sale activity the consumer may also be offered a secondary service such as CE device maintenance or network provision service. For example, if the consumer buys a computer the consumer may be offered to register with a computer repair service provider.

A retailer/credit card company/consumer information buyer/seller/broker 3 6 use case can now be understood. Since the entity 36 desires consumer information for a variety of reasons, the entity 36 can contract with the CE manufacturer to provide non-personally identifiable information on potential customers. Metadata information is gathered as described above (e.g., change of address, change of email address, change in contact phone number, etc.) and provided, for a fee, to the entity 36. Targeted advertising from the entity 36 can then be provided to the consumer based on this metadata to thereby provide improved correlation of the consumer with needed products or services. The CE manufacturer also obtains value from the updated contact information.

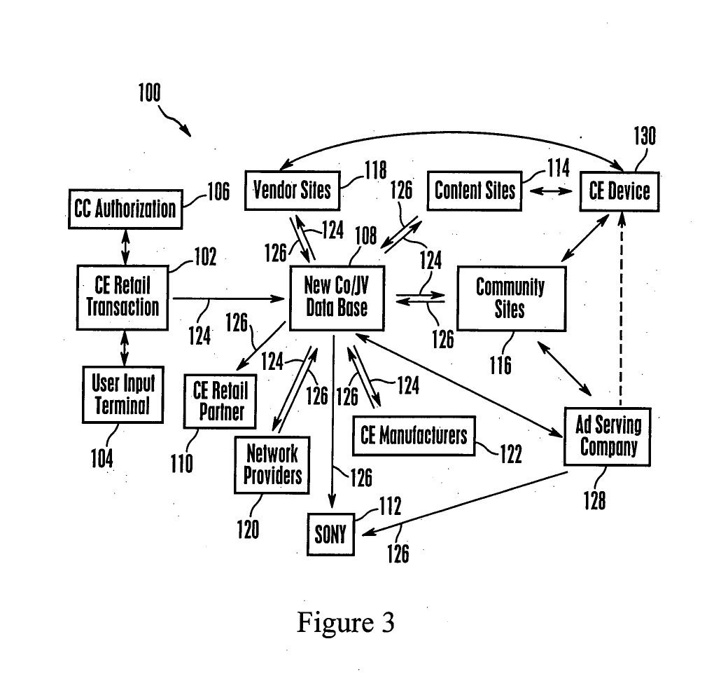

FIG. 3 illustrates a system 100 that embodies above principles. A consumer electronics (CE) retail transaction computer 102 may receive input from a user input terminal 104 for executing a retail transaction that can include authorizing a credit card (CC) transaction from a remotely-located CC authorization computer 106. The transaction information, including type and serial number/model number of the CE that is purchased, CC data, and if desired the above-mentioned registration data can be sent to a database 108 that potentially may be a joint venture database between, e.g., a CE retail partner 110 such as a CE retail outlet and a principal CE manufacturer 112 such as Sony Corp. The registration information in the database 108 may be accessed by various entities for a fee. For example, content websites 114, community websites 116, vendor websites 118, network providers (such as telephone service providers) 120, and other CE manufacturers 122 may access the database 108 to receive registration information, indicated by arrows 124, in exchange for fees, indicated by arrows 126. As shown in FIG. 3, the CE retail partner 110 and principal CE manufacturer 112 may also receive fees 126 for the provision of registration information 124.

If desired, an ad serving company computer 128 may communicate with the database 108, principal CE manufacturer 112, and community websites 116 to receive registration information to better tailor advertising to purchasers. A purchased and registered CE device 130 may receive advertising wirelessly or via wired networking from the ad computer 130, and may communicate with the content websites 114 and community websites 116 as shown in accordance with principles known in the art.

While the particular SYSTEM AND METHOD FOR METADATA USE IN ADVERTISING is herein shown and described in detail, it is to be understood that the subject matter which is encompassed by the present invention is limited only by the claims.

What is claimed is:

1. A method for using customer data gathered at a point of sale for later advertising, comprising:
gathering consumer information related to a consumer from at least one merchant regarding a product at time of purchase to affect service registration and/or product registration and/or warranty registration;
gathering metadata from the consumer information from at least the point of sale to determine potential use of the product; and
using at least the consumer information and/or the metadata from the consumer information to market goods and/or services to the consumer.

2. The method of claim 1, wherein the act of using to market goods and/or services includes direct marketing.

3. The method of claim 1, wherein the act of using to market goods and/or services includes advertising servicing and/or placement.

4. The method of claim 1, wherein the act of using to market goods and/or services includes rendering to the consumer product updates and/or services.

5. The method of claim 1, wherein the act of using to market goods and/or services includes correlation of other existing and/or future consumer information.

6. A method for detecting potential demand for second goods and/or services by a purchaser of first goods and/or services, comprising:
gathering consumer information related to a consumer from at least one merchant regarding a product at time of purchase to affect service registration and/or product registration and/or warranty registration;
gathering metadata from the consumer information from at least the point of sale to determine potential use of the product; and
providing at least the consumer information and/or the metadata from the consumer information to a provider of goods and/or services, the provider being other than the merchant.

7. The method of claim 6, wherein the provider is a retailer.

8. The method of claim 6, wherein the provider is a manufacturer.

9. The method of claim 6, wherein the provider is an owner of a web site.

10. The method of claim 6, wherein the information and/or metadata is used as marketing information to improve products and product mix.

11. The method of claim 10, wherein if the information and/or metadata indicates that consumers are buying many camera-enabled wireless phones with short-range radiofrequency communication capability, and secondary service information reveals problems transferring images from cell phones to TVs for display of the images, a TV manufacturer is given early warning of a consumer demand for TVs enabled with short-range radiofrequency communication capability.

12. The method of claim 6, wherein the information and/or metadata is used to indicate updated consumer contact information.

13. The method of claim 12, wherein the updated consumer contact information is used to provide written or electronic advertising materials to the consumer either directly or through a third party aggregator by correlating data from the consumer, the purchased product, and a retail outlet at which the product was purchased.

14. The method of claim 6, wherein the provider is an owner of a website and the consumer is offered a registration related to the website and to the product, the consumer providing additional information as part of registration, the provider remitting consideration to a retail outlet at which the product was purchased at least partially based on the registration.

15. The method of claim 14, wherein the consumer is offered the service associated with the website as a first option and if the user selects the first option and executes registration, the consumer is provided consideration by the provider.

16. The method of claim 15, wherein the provider displays on the website at least one advertisement for a manufacturer of the purchased product if the consumer executes registration selecting the first option.

17. The method of claim 6, wherein the provider is an entity desiring information related to the consumer, and information is provided for a fee to the entity, the entity then providing targeted advertising to the consumer to provide improved correlation of the consumer with needed products or services.

18. A method comprising:
gathering first consumer data at a point of sale of a consumer electronics (CE) device, the first consumer data being automatically gathered from at least consumer-provided payment instrument and from at least product identification;
incentivizing a consumer to provide second data related to the consumer at the point of sale; and
using at least the second data to undertake at least one of: marketing additional products to the consumer, facilitating service provision to the consumer related to the CE device by a third party service provider, or providing the second data to an entity for a fee such that the entity can provide targeted advertising to the consumer to provide improved correlation of the consumer with needed products or services.

19. The method of claim 18, wherein the second data is used to indicate updated consumer contact information, the updated consumer contact information being used to provide written or electronic advertising materials to the consumer either directly or through a third party aggregator by correlating data from the consumer, the CE device, and a retail outlet at which the CE device was purchased.

20. The method of claim 18, wherein the third party service provider is an owner of a website and the consumer is offered a registration related to the website and to the CE device, the consumer providing additional information as part of registration, the provider remitting consideration to a retail outlet at which the CE device was purchased at least partially based on the registration, wherein the consumer is offered a service associated with the website as a first option and if the user selects the first option and executes registration, the consumer is paid consideration by the provider.
